(19) United States
(12) Patent Application Publication
(10) Pub. No.: US 2010/0252950 A1
(43) Pub. Date: Oct. 7, 2010

(54) METHOD OF PRODUCING POLYCRYSTALLINE TRANSPARENT CERAMIC SUBSTRATE AND METHOD OF PRODUCING SPINEL SUBSTRATE

(75) Inventors: Masashi Yoshimura, Itami-shi (JP); Akihito Fujii, Osaka-shi (JP); Shigeru Nakayama, Osaka-shi (JP)

Correspondence Address: GLOBAL IP COUNSELORS, LLP, 1233 20TH STREET, NW, SUITE 700, WASHINGTON, DC, 20036-2680, US

(73) Assignee: SUMITOMO ELECTRIC INDUSTRIES, LTD., Osaka-shi, Osaka (JP)

(21) Appl. No.: 12/743,778

(22) PCT Filed: Nov. 21, 2008
(86) PCT No.: PCT/JP2008/071235

§ 371 Date: May 19, 2010

(30) Foreign Application Priority Data
Nov. 26, 2007 (JP) 2007-304258

(51) Int. Cl. C04B 41/81

(52) U.S. Cl. 264/133

(57) ABSTRACT

There is provided a method of producing a polycrystalline transparent ceramic substrate used in a transparent substrate or the like for a liquid crystal projector. The method of producing a polycrystalline transparent ceramic substrate is characterized in comprising a step for sintering a ceramic body molded into a predetermined shape and producing a polycrystalline transparent ceramic sintered body, a step for cutting the polycrystalline transparent ceramic sintered body and producing a plurality of polycrystalline transparent ceramic cut bodies, a step for polishing the cut surfaces of the polycrystalline transparent ceramic cut bodies and producing polycrystalline transparent ceramic polished bodies, and a step for applying an antireflection coating to the polycrystalline transparent ceramic polished bodies and producing coated polycrystalline transparent ceramic bodies.

### TECHNICAL FIELD

The present invention relates to a method of producing a polycrystalline transparent ceramic substrate and to a method of producing a spinel substrate. The present invention also relates to methods of producing a polycrystalline transparent ceramic substrate and a spinel substrate that are used in optical products for electronics applications, particularly transparent substrates and the like for liquid crystal projectors.

### BACKGROUND ART

Over the past several years, liquid crystal projectors have become commercially available. In these products, the front and back sides of a liquid crystal screen are made transparent, one side acting as a liquid crystal panel is exposed to light, and the transmitted light is adjusted by a lens or the like. Transparent substrates for protecting liquid crystal screens in these types of liquid crystal projectors are required not only to merely protect the liquid crystal screens from dirt or air, but also to provide thermal protection from the adjacent light source, to release the heat of rising temperatures accompanying the phenomenon of heat absorption generated in the liquid crystal screen by the light from the light source, and the like.

Recently, polycrystalline transparent ceramic substrates having excellent transparency, of which spinel (MgO·nAl₂O₃; n=1 to 3) is representative, have come into use as these types of transparent substrates. Magnesium oxide (MgO), aluminum nitride (AlN), zinc sulfide (ZnS), and the like can also be listed as polycrystalline transparent ceramics.

Spinel substrates having good transparency and methods of producing the spinel substrates are disclosed in Patent Literature 1 to 3.

[Patent Literature 1] Japanese Published Examined Application No. 6-72045

[Patent Literature 2] Japanese Laid-open Patent Publication No. 2006-273679

[Patent Literature 3] Japanese Translation of PCT International Application No. 4-502748

### DISCLOSURE OF THE INVENTION

### Technical Problem

However, the conventional methods for producing a spinel substrate disclosed in Patent Literature 1 through 3, in which spinel sintered bodies individually produced to predetermined dimensions are polished, coated with antireflection (AR) coatings, and made into predetermined spinel substrates, cannot provide spinel substrates inexpensively.

There is a demand for a production method that can inexpensively provide not only spinel substrates, but other polycrystalline transparent ceramic substrates as well.

Accordingly, the present invention is intended to provide an inexpensive method of producing a polycrystalline transparent ceramic substrate for use in a transparent substrate or the like for a liquid crystal projector.

### Solution to Problems

The inventors discovered that a polycrystalline transparent ceramic substrate can be inexpensively produced using the production methods disclosed by the below-described aspects, and developed the present invention.

The invention according to each aspect is described below.

A first aspect of the invention of the present application is a method of producing a polycrystalline transparent ceramic substrate, characterized by comprising the steps of:

producing a polycrystalline transparent ceramic sintered body by sintering a ceramic body molded into a predetermined shape;

producing a plurality of polycrystalline transparent ceramic cut bodies by cutting the polycrystalline transparent ceramic sintered body;

producing a polycrystalline transparent ceramic polished body by polishing a cut surface of the polycrystalline transparent ceramic cut body; and

producing a coated polycrystalline transparent ceramic body by applying an antireflection coating to the polycrystalline transparent ceramic polished body.

In the invention according to the first aspect, the polycrystalline transparent ceramic sintered bodies produced in a predetermined shape (for example, a rod or block shape) are cut, polished, coated with an antireflection coating, and subsequently cut into a predetermined shape to produce a polycrystalline transparent ceramic substrate, unlike with conventional production methods in which the substrates are produced individually. Therefore, a large number of polycrystalline transparent ceramic substrates can be produced at once, and the polycrystalline transparent ceramic substrates can be produced inexpensively.

A second aspect of the invention of the present application is a method of producing a spinel substrate, characterized by comprising the steps of:

producing a spinel sintered body by sintering a spinel formed body molded into a predetermined shape;

producing a plurality of spinel cut bodies by cutting the spinel sintered body;

producing a spinel polished body by polishing a cut surface of the spinel cut body; and

producing a coated spinel body by applying an antireflection coating to the spinel polished body.

The invention according to the second aspect is a method of producing a polycrystalline transparent ceramic substrate, i.e., a spinel substrate, using a spinel sintered body.

In the invention according to the second aspect, the spinel sintered body produced in a predetermined shape (for example, a rod or block shape) is cut, polished, coated with an antireflection coating, and subsequently cut into a predetermined shape to manufacture spinel substrates, unlike with conventional production methods in which the substrates are produced individually. Therefore, a large number of spinel substrates can be produced at once, and the spinel substrates can be produced inexpensively.

Each step according to the second aspect will be described hereinbelow.

(Step for Producing a Spinel Sintered Body)

Spinel powder is molded in a press or the like into a predetermined shape and then sintered in a vacuum or in a predetermined atmosphere to manufacture a spinel sintered body. At this stage, the pre-sintering density is sometimes insufficient, and the transparency is sometimes inadequate. Densification is performed in such cases using hot pressing or hot isostatic pressing (HIP), and a spinel sintered body is produced having excellent transparency.

In a case where hot isostatic pressing is used in the situation described above, the resulting spinel sintered body has a transmittance of 84% or greater at a thickness of 1 mm for visible light having a wavelength of 450 nm, and better transparency than when hot pressing is used. Using hot isostatic pressing is therefore preferable. The HIP pressure is preferably about 100 to 200 MPa. The HIP temperature is preferably 1700 to 1850° C.

(Step for Cutting the Spinel Sintered Body)

The resulting spinel sintered body is cut at a predetermined thickness to manufacture a plurality of spinel cut bodies. Since a plurality of spinel cut bodies can be produced at the same time, the method is more efficient than conventional production methods.

The predetermined thickness in the abovementioned case is the thickness obtained by taking into account the polishing and the like in the subsequent steps.

Also, the cutting thickness need not be the same, and cutting to different thicknesses may also be employed. Since the spinel cut bodies can be produced having different thicknesses, it is possible to promptly accommodate demand for spinel transparent substrates having different thicknesses.

(Step for Polishing the Spinel Cut Bodies)

Since the cut surfaces of the spinel cut bodies are roughened by the cutting, the transparency in the cut-surface direction will be adversely affected if the surfaces are left untreated. Accordingly, the cut surfaces are polished and smoothed to restore transparency. The same polishing methods (for example, polishing by using loose grains, or the like) as in conventional production methods can be used. The surface roughness of the polished surfaces is preferably Ra≦0.01 μm, and the degree of parallelization and the warpage are each preferably 10 μm or less.

(Step for Applying an Antireflection Coating to the Spinel Polished Bodies)

An antireflection coating treatment is applied to the surface (one or both sides) in order to improve the transparency characteristics and surface stability of the spinel polished bodies. It is possible to directly use the coating materials and coating methods usually employed in conventional production methods (for example, the coating material may be MgF₂, TiO₂, or the like; and the coating method may be a vacuum deposition method, chemical vapor deposition (CVD) method, or the like).

The coated spinel bodies obtained via the above-described steps can be used as spinel substrates, but it is also possible to manufacture large coated spinel bodies in advance and use a dicing saw or the like to cut the coated spinel bodies to predetermined dimensions, thereby obtaining spinel substrates having predetermined dimensions. In this instance, since the coated spinel bodies are spinel sintered bodies that have already been coated on one or both sides, a large number of spinel substrates can be obtained simultaneously with the cutting, and the spinel substrates can be produced inexpensively and efficiently.

A third aspect of the invention of the present application is the method of producing a spinel substrate according to the second aspect, characterized by further comprising the step of molding the spinel formed body using at least one selected from the group consisting of normal pressing and cold isostatic pressing.

In the invention according to the third aspect, press molding matched to a predetermined shape is commonly used in molding the spinel powder, and cold isostatic pressing (CIP) can be used in cases in which the filling factor is to be further increased. A more uniform spinel formed body can thereby be produced.

Cold isostatic pressing is preferable from the standpoint of providing the formed body with uniform density. The CIP pressure is preferably about 100 to 200 MPa.

It is preferable to perform primary molding by press molding, and then to perform secondary molding by CIP.

A fourth aspect of the invention of the present application is the method of producing a spinel substrate according to the second or third aspect, characterized in that the step of producing the plurality of spinel cut bodies comprises the steps of: polishing the spinel sintered body to adjust an exterior shape thereof; and cutting the spinel sintered body having the adjusted exterior shape with a wire saw or a blade saw.

In the invention according to the fourth aspect, sintering in air atmosphere or vacuum sintering is used when the spinel formed body is sintered. The sintering method can be selected as appropriate according to the amount of impurities in the spinel powder. For example, sintering in air atmosphere is used in a case in which a large amount of organic binder is contained.

Furthermore, the transparency characteristics can preferably be further improved when pressure sintering is performed using atmosphere sintering after sintering in air atmosphere or vacuum sintering has been completed. In the atmosphere sintering, the atmosphere is preferably nitrogen, argon, or oxygen.

A fifth aspect of the invention of the present application is the method of producing a spinel substrate according to any of the second through fourth aspects, characterized in that the step of producing the plurality of spinel cut bodies comprises the steps of:

polishing the spinel sintered body to adjust an exterior shape thereof; and

cutting the spinel sintered body having the adjusted exterior shape with a wire saw or a blade saw.

Efficient cutting can be performed in the invention according to the fifth aspect because the spinel cut bodies are produced using a wire saw or a blade saw after the exterior shape of the spinel sintered body is adjusted by polishing.

Polishing the exterior of the spinel sintered body removes the irregularities on the surface of the spinel sintered body, and hence makes it possible to reduce waste during cutting. Furthermore, the necessary adjustment to the dimensions, the degree of parallelization, and the like in a spinel substrate for use in a liquid crystal projector can be performed in this step.

When cutting is performed using a wire saw, a large number can be cut in one cycle, and the spinel substrates can be obtained more efficiently.

A sixth aspect of the invention of the present application is the method of producing a spinel substrate according to any of the second through fifth aspects, characterized in that the step of producing the spinel polished body is conducted using a lapping plate.

Since the spinel cut bodies are polished using a lapping plate in the invention according to the sixth aspect, the cut surfaces can be polished to a greater degree of smoothness.

In the second through sixth aspects above, a method of producing a spinel substrate from a spinel sintered body was described, but the production method disclosed in each of the aspects can be applied not only to spinel sintered bodies, but also to magnesium oxide, aluminium nitride, zinc sulfide, and a variety of other polycrystalline transparent ceramic bodies.

In this case, the CIP pressure is preferably about 100 to 200 MPa. The HIP temperature is preferably 1400 to 1900° C., and the polycrystalline transparent ceramic sintered bodies produced using hot isostatic pressing have a transmittance of 80% or greater at a thickness of 1 mm for visible light having a wavelength of 450 nm. It is possible to provide a transparent polycrystalline ceramic sintered body having excellent in-line transparency by appropriately coating either side or both sides of the body with an antireflection coating. MgF₂, YF₃, LaF₃, CeF₃, BaF₂, or another metal fluoride is preferably used as the antireflection coating. Multilayering with SiO₂, TiO₂, Al₂O₃, Y₂O₃, Ta₂O₅, ZrO₂, and other metal oxides is also possible. A physical vapor deposition method can be used as the means for providing the antireflection coating; specific examples include sputtering methods, ion plating methods, and vacuum vapor deposition methods.

### Effect of the Invention

A polycrystalline transparent ceramic substrate that can be used for a transparent substrate or the like in a liquid crystal projector can be produced inexpensively by applying the method of producing a polycrystalline transparent ceramic substrate according to the present invention.

### DESCRIPTION OF THE PREFERRED EMBODIMENTS

A preferred embodiment of the present invention is described in more detail below on the basis of an example. The present invention is not limited to the embodiment described below. A variety of modifications may be added to the below-described embodiment within a scope that is identical and equivalent to the present invention.

It should be noted that although spinel is used in the example below, magnesium oxide, aluminium nitride, zinc sulfide, and other similar compounds can also be applied to the polycrystalline transparent ceramic substrates.

### EXAMPLE

Each step of the example is described below.

(Producing a Spinel Sintered Body)

Spinel powder (MgO·nAl₂O₃; n=1.05 to 1.30) was shaped in a press into a rod shape by primary molding (molding condition: 196 MPa), and was further shaped into a spinel formed body by secondary molding using cold isostatic pressing (condition: 196 MPa).

The spinel formed body was subsequently vacuum sintered (conditions: 1650° C.×4 hours), and a spinel sintered body was obtained. Pressure and heat were further applied using hot isostatic pressing (conditions: 1750° C.×2 hours, 200 MPa), the surface was subsequently ground, irregularities were removed, and a rod-shaped spinel sintered body measuring 20×18×130 mm was ultimately obtained.

(Cutting the Spinel Sintered Body)

The rod-shaped spinel sintered body was cut to a thickness of 1.2 mm using a multi-wire saw (manufacturer: Yasunaga Corporation), and 80 spinel cut bodies were produced.

(Polishing the Spinel Cut Bodies)

The cut surface of each spinel cut body was polished using a lapping plate, and a spinel polished body was produced having a thickness of 20×18×1 mm (loose grain diamonds of 9, 3, and 1 μm were used). Here, the surface roughness was Ra=0.007 μm, the degree of parallelization was 5.2 μm, and the warpage was 2.3 μm.

(Applying the Antireflection Coating)

Using a vacuum deposition method, a single-layer coating of MgF₂ was applied to 0.1 μm on one surface of the completely polished spinel polished body.

The post-coating transparency was 91% or greater for visible light having a wavelength of 450 nm.

When the producing method of the present invention is used as described above, a large number of spinel substrates can be produced at once.

1. A method of producing a polycrystalline transparent ceramic substrate, comprising:
producing a polycrystalline transparent ceramic sintered body by sintering a ceramic body molded into a predetermined shape;
producing a plurality of polycrystalline transparent ceramic cut bodies by cutting the polycrystalline transparent ceramic sintered body;
producing a polycrystalline transparent ceramic polished body by polishing a cut surface of the polycrystalline transparent ceramic cut body; and
producing a coated polycrystalline transparent ceramic body by applying an antireflection coating to the polycrystalline transparent ceramic polished body.

2. A method of producing a spinel substrate, comprising:
producing a spinel sintered body by sintering a spinel formed body molded into a predetermined shape;
producing a plurality of spinel cut bodies by cutting the spinel sintered body;
producing a spinel polished body by polishing a cut surface of the spinel cut body; and
producing a coated spinel body by applying an antireflection coating to the spinel polished body.

3. The method of producing a spinel substrate according to claim 2, wherein
the sintering of the spinel formed body includes molding using at least one selected from the group consisting of normal pressing and cold isostatic pressing.

4. The method of producing a spinel substrate according to claim 2,
wherein the producing of the spinel sintered body includes one of the following: vacuum sintering, sintering in air atmosphere, and atmosphere sintering.

5. The method of producing a spinel substrate according to claim 2, wherein
the producing of the plurality of spinel cut bodies includes using a wire saw or a blade saw after the exterior shape of the spinel sintered body is adjusted by polishing.

6. The method of producing a spinel substrate according to claim 2, wherein, producing the spinel polished bodies includes conducted using a lapping plate.

7. The method of producing a spinel substrate according to claim 2, wherein the spinel formed body is molded using cold isostatic pressing.

8. The method of producing a spinel substrate according to claim 2, wherein the spinel formed body is molded using normal pressing.
